(19) United States
(12) Patent Application Publication
(10) Pub. No.: US 2015/0140882 A1
(43) Pub. Date: May 21, 2015

(54) FUSER MEMBER AND METHOD OF MANUFACTURE

(71) Applicant: Xerox Corporation, Norwalk, CT (US)

(72) Inventors: Yu Qi, Penfield, NY (US); Brynn Mary Dooley, Toronto (CA); Suxia Yang, Mississauga (CA); Ping Liu, Mississauga (CA); Nan-Xing Hu, Oakville (CA)

(73) Assignee: Xerox Corporation, Norwalk, CT (US)

(21) Appl. No.: 14/082,801

(22) Filed: Nov. 18, 2013

(51) Int. Cl. G03G 15/20; B05D 3/00

(52) U.S. Cl. CPC G03G 15/2057; B05D 3/002; B05D 2350/60
USPC 442/52; 427/58

(57) ABSTRACT

A fuser member including a substrate and a release layer disposed on the substrate is described. The release layer includes a metal coated non-woven polymer fiber mesh wherein the metal coated non-woven polymer fiber mesh has pores of a size of from about 1 microns to about 50 microns and a fluoropolymer dispersed on and throughout the polymer matrix. A method of manufacturing the fuser member is also provided.

### CROSS REFERENCE TO RELATED APPLICATIONS

This application relates to commonly assigned copending application Ser. No. ______ (Docket No. 20121112-US-NP) entitled “Fuser Member and Composition of Matter” and commonly assigned copending application Ser. No. ______ (Docket No. 20121113-US-NP) entitled “Surface Layer and Fuser Member” all filed simultaneously herewith and incorporated by reference herein in their entirety.

### BACKGROUND

1. Field of Use

This disclosure is generally directed to surface layers for fuser members useful in electrophotographic imaging apparatuses, including digital, image on image, and the like.

2. Background

Generally, in a commercial electrophotographic marking or reproduction apparatus (such as copier/duplicators, printers, multifunctional systems or the like), a latent image charge pattern is formed on a uniformly charged photoconductive or dielectric member. Pigmented marking particles (toner) are attracted to the latent image charge pattern to develop this image on the photoconductive or dielectric member. A receiver member, such as paper, is then brought into contact with the dielectric or photoconductive member and an electric field applied to transfer the marking particle developed image to the receiver member from the photoconductive or dielectric member. After transfer, the receiver member bearing the transferred image is transported away from the dielectric member to a fusion station and the image is fixed or fused to the receiver member by heat and/or pressure to form a permanent reproduction thereon. The receiving member passes between a pressure roll and a heated fuser roll or element.

Fluoropolymers have utility in a variety of applications due to superior chemical and thermal stability, as well a low coefficient of friction. Fluoropolymers are thermally insulating and thus heat transfer through a fluoropolymeric coating is poor.

Higher fusing speed can be achieved by increasing the thermal conductivity of the surface layer of the fuser member. Increased thermal conductivity of the fuser surface also allows for a lower fusing temperature and a wider fusing latitude. Various thermally conductive fillers have been disclosed for increasing thermal conductivity of the fuser surface. Carbon nanotubes (CNT) having a fluoroelastomer sheath dispersed in a fluoroplastic are described in U.S. Pat. No. 7,991,340. However, carbon nanotubes are costly to produce and available in relatively small quantities compared to other bulk chemicals. In addition, the production of carbon nanotubes is energy intensive. Furthermore, the impact on the environment and human health from long-term exposure to freeform carbon nanotubes is unknown. Fuser surfaces having increased thermal conductivity without negatively impacting fusing performance are desired.

### SUMMARY

According to an embodiment, there is provided a fuser member including a substrate and a release layer disposed on the substrate. The release layer includes a metal coated non-woven polymer fiber mesh wherein the metal coated non-woven polymer fiber mesh has pores of a size of from about 1 micron to about 50 microns and a fluoropolymer dispersed on and throughout the polymer matrix.

According to another embodiment, there is provided a fuser member having a substrate, an intermediate layer disposed on the substrate and a release layer disposed on the intermediate layer. The intermediate layer is a fluoroelastomer and silicone. The release layer is a metal coated non-woven polymer fiber mesh having pores of a size of from about 1 micron to about 50 microns, and a fluoropolymer dispersed on and throughout the metal coated non-woven polymer fiber mesh.

According to another embodiment, there is provide a method of manufacturing a fuser member. The method includes providing a conductive substrate and electrospinning polymeric fibers on the conductive surface to form a non-woven polymer fiber layer. A metal particle dispersion is coated on on the polymeric fibers. The metal particle dispersion is annealed to form a metal coated non-woven polymer fiber mesh having pores having a size of from about 1 microns to about 50 microns. A mixture of a fluoropolymer and a solvent is coated on the metal coated non-woven polymer fiber mesh. The mixture is heated to remove the solvent and melt or cure the fluoropolymer wherein the fluoropolymer penetrates the metal coated non-woven polymer fiber mesh.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 depicts an exemplary fusing member having a cylindrical substrate in accordance with the present teachings.

FIG. 2 depicts an exemplary fusing member having a belt substrate in accordance with the present teachings.

FIGS. 3A-3B depict exemplary fusing configurations using the fuser rollers shown in FIG. 1 in accordance with the present teachings.

FIGS. 4A-4B depict another exemplary fusing configuration using the fuser belt shown in FIG. 2 in accordance with the present teachings.

FIG. 5 depicts an exemplary fuser configuration using a transfix apparatus.

It should be noted that some details of the FIGS. have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Illustrations with respect to one or more implementations, alterations and/or modifications can be made to the illustrated examples without departing from the spirit and scope of the appended claims. In addition, while a particular feature may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

Disclosed herein is a surface layer for a fuser member and a method of making the fuser member. Coatings containing a metal coated non-woven polymer fiber mesh having fluoropolymer dispersed throughout the mesh are described. More specifically, a fuser member can be prepared by coating a polymer fiber mat on an intermediate layer of the fuser member via an electrospinning process. Metal nanoparticle dispersions, such as silver ink, can be coated onto the non-woven polymer fiber mat. The dispersion is heated to form a continuous metal coating on the non-woven polymer fiber mat to create a metal coated non-woven polymer fiber mesh with pores on the order of about 10 microns to about 40 microns. A fluoropolymer mixture is flow-coated onto the metallic mesh to result in a thermally conductive fuser topcoat with excellent toner release properties.

Polyimide membranes comprising a mat of non-woven polyimide fibers having a fluoropolymer sheath are described in U.S. Ser. No. 13/444,366 filed on Apr. 11, 2012 and incorporated in its entirety by reference herein. Polyimide membranes comprising a mat of non-woven polyimide and siloxyfluorocarbon are described in U.S. Ser. No. 13/706,027 filed on Dec. 5, 2013 and incorporated in its entirety by reference herein.

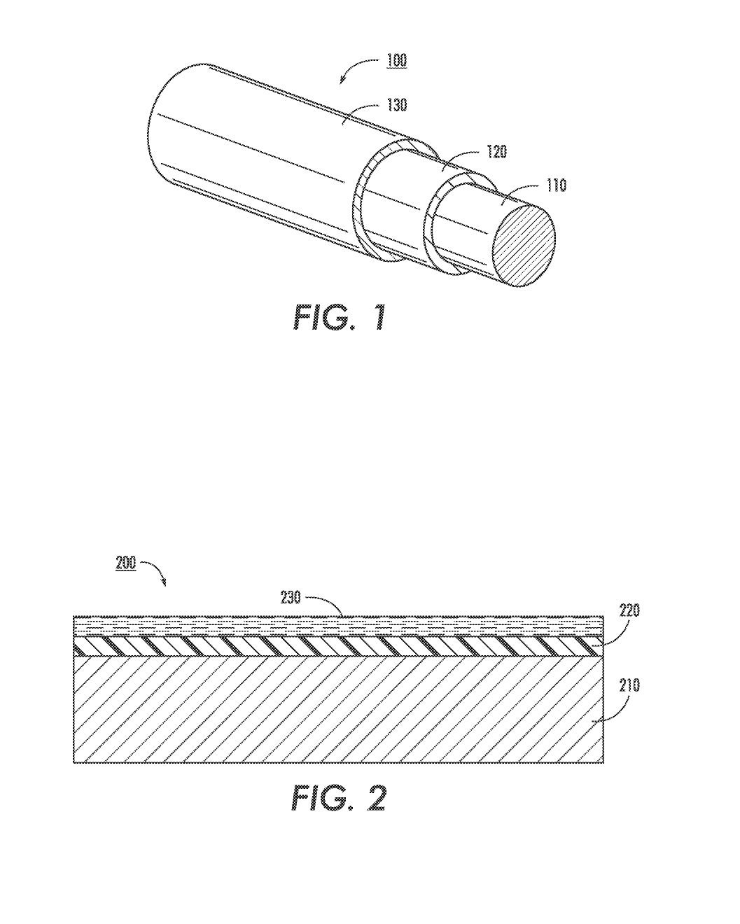

In various embodiments, the fixing member can include, for example, a substrate, with one or more functional layers formed thereon. The substrate can be formed in various shapes, e.g., a cylinder (e.g., a cylinder tube), a cylindrical drum, a belt, or a film, using suitable materials that are non-conductive or conductive depending on a specific configuration, for example, as shown in FIGS. 1 and 2.

Specifically, FIG. 1 depicts an exemplary fixing or fusing member 100 having a cylindrical substrate 110 and FIG. 2 depicts in cross-section another exemplary fixing or fusing member 200 having a belt substrate 210 in accordance with the present teachings. It should be readily apparent to one of ordinary skill in the art that the fixing or fusing member 100 depicted in FIG. 1 and the fixing or fusing member 200 depicted in FIG. 2 represent generalized schematic illustrations and that other layers/substrates can be added or existing layers/substrates can be removed or modified.

In FIG. 1, the exemplary fixing member 100 can be a fuser roller having a cylindrical substrate 110 with one or more functional layers 120 (also referred to as intermediate layers) and a surface layer 130 formed thereon. In embodiments detailed herein the surface layer 130 can be two distinct layers. This is not shown in FIG. 1. In various embodiments, the cylindrical substrate 110 can take the form of a cylindrical tube, e.g., having a hollow structure including a heating lamp therein, or a solid cylindrical shaft. In FIG. 2, the exemplary fixing member 200 can include a belt substrate 210 with one or more functional layers, e.g., 220 and an outer surface 230 formed thereon. In embodiments detailed herein the surface layer 230 can be two distinct layers. This is not shown in FIG. 2.

### Substrate Layer

The belt substrate 210 (FIG. 2) and the cylindrical substrate 110 (FIG. 1) can be formed from, for example, polymeric materials (e.g., polyimide, polyaramide, polyether ether ketone, polyetherimide, polyphthalamide, polyamide-imide, polyketone, polyphenylene sulfide, fluoropolyimides or fluoropolyurethanes) and metal materials (e.g., aluminum or stainless steel) to maintain rigidity and structural integrity as known to one of ordinary skill in the art.

Intermediate Layer

Examples of intermediate or functional layers 120 (FIG. 1) and 220 (FIG. 2) include fluorosilicones, silicone rubbers such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC® 735 black RTV and SILASTIC® 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials include the siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182. Commercially available LSR rubbers include Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR from Dow Corning. The functional layers provide elasticity and can be mixed with inorganic particles, for example SiC or Al₂O₃, as required.

Examples of intermediate or functional layers 120 (FIG. 1) and 220 (FIG. 2) also include fluoroelastomers. Fluoroelastomers are from the class of 1) copolymers of two of vinylidenefluoride, hexafluoropropylene, and tetrafluoroethylene; such as those known commercially as VITON A®, 2) terpolymers of vinylidenefluoride, hexafluoropropylene, and tetrafluoroethylene such as those known commercially as VITON B®; and 3) tetrapolymers of vinylidenefluoride, hexafluoropropylene, tetrafluoroethylene, and a cure site monomer, such as those known commercially as VITON GH® or VITON GF®. These fluoroelastomers are known commercially under various designations such as those listed above, along with VITON E®, VITON E 60C®, VITON E430®, VITON 910®, and VITON ETP®. The VITON® designation is a trademark of E.I. DuPont de Nemours, Inc. The cure site monomer can be 4-bromoperfluorobutene-1, 1,1-dihydro-4-bromoperfluorobutene-1, 3-bromoperfluoropropene-1, 1,1-dihydro-3-bromoperfluoropropene-1, or any other suitable, known cure site monomer, such as those commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene), and FLUOREL II® (LII900) a poly(propylene-tetrafluoroethylenevinylidenefluoride), both also available from 3M Company, as well as the Tecnoflons identified as FOR-60KIR®, FOR-LHF®, NM® FOR-THF®, FOR-TFS®, TH®, NH®, P757®, TNS®, T439®, PL958®, BR9151® and TN505®, available from Ausimont.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer. Cure site monomers are available from Dupont.

For a roller configuration, the thickness of the intermediate or functional layer can be from about 0.5 mm to about 10 mm, or from about 1 mm to about 8 mm, or from about 2 mm to about 7 mm. For a belt configuration, the functional layer can be from about 25 microns up to about 2mm, or from 40 microns to about 1.5 mm, or from 50 microns to about 1 mm.

### Release Layer or Surface Layer

A fuser surface including a metal coated non-woven polymer fiber mesh with pores on the order of about 1 micron to about 50 microns having fluoropolymer dispersed throughout is described. In embodiments, the pores are the order of 5 microns to about 40 microns, or from about 10 microns to about 35 microns.

Additives and additional conductive or non-conductive fillers may be present in the substrate layers 110 (FIG. 1) and 210 (FIG. 2), the intermediate layers 120 (FIG. 1) and 220 (FIG. 2) and the release layers 130 (FIG. 1) and 230 (FIG. 2). In various embodiments, other filler materials or additives including, for example, inorganic particles, can be used for the coating composition and the subsequently formed surface layer. Conductive fillers used herein may include carbon blacks such as carbon black, graphite, graphene, carbon nanotubes, alumina, fullerene, acetylene black, fluorinated carbon black, and the like; carbon nanotubes; metal oxides and doped metal oxides, such as tin oxide, antimony dioxide, antimony-doped tin oxide, titanium dioxide, indium oxide, zinc oxide, indium oxide, indium-doped tin trioxide, and the like; and mixtures thereof. Certain polymers such as polyanilines, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene, salts of organic sulfonic acid, esters of phosphoric acid, esters of fatty acids, ammonium or phosphonium salts and mixtures thereof can be used as conductive fillers. In various embodiments, other additives known to one of ordinary skill in the art can also be included to form the disclosed composite materials.

### Adhesive Layer

Optionally, any known and available suitable adhesive layer may be positioned between the outer layer or surface layer and the intermediate layer or between the intermediate layer and the substrate layer. Examples of suitable adhesives include silanes such as amino silanes (such as, for example, HV Primer 10 from Dow Corning), titanates, zirconates, aluminates, and the like, and mixtures thereof. In an embodiment, an adhesive in from about 0.001 percent to about 10 percent solution can be wiped on the substrate. The adhesive layer can be coated on the substrate, or on the outer layer, to a thickness of from about 2 nanometers to about 10,000 nanometers, or from about 2 nanometers to about 1,000 nanometers, or from about 2 nanometers to about 5000 nanometers. The adhesive can be coated by any suitable known technique, including spray coating or wiping.

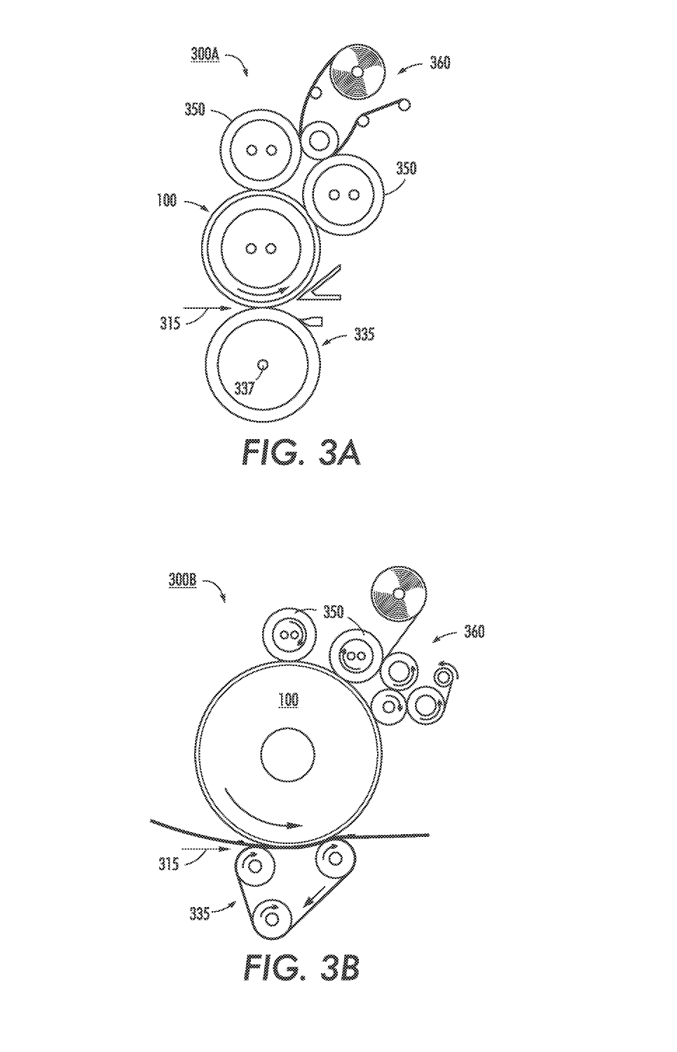

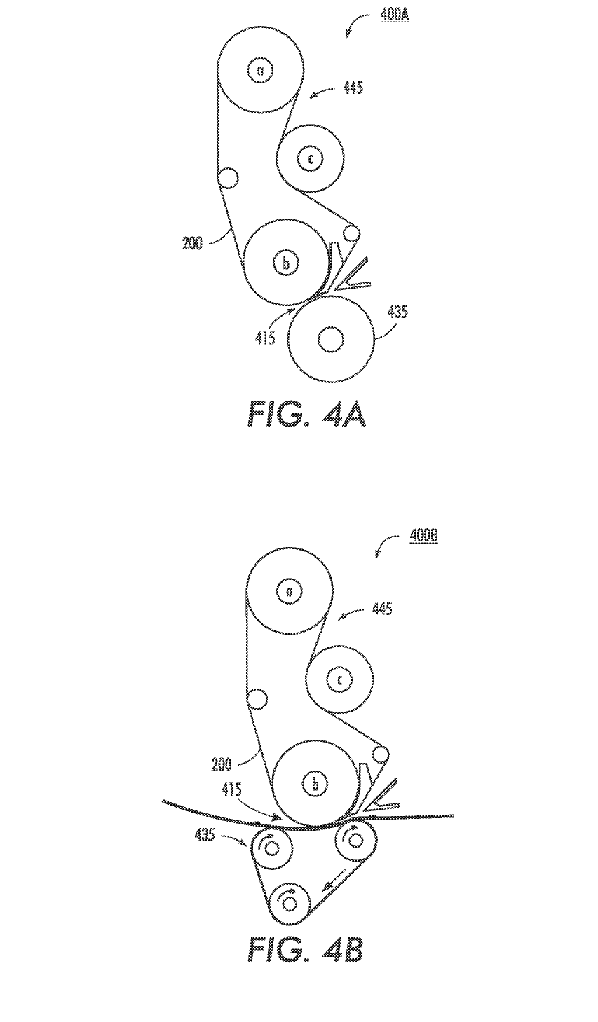

FIGS. 3A-3B and FIGS. 4A-4B depict exemplary fusing configurations for the fusing process in accordance with the present teachings. It should be readily apparent to one of ordinary skill in the art that the fusing configurations 300A-B depicted in FIGS. 3A-3B and the fusing configurations 400A-B depicted in FIGS. 4A-4B represent generalized schematic illustrations and that other members/layers/substrates/configurations can be added or existing members/layers/substrates/configurations can be removed or modified. Although an electrophotographic printer is described herein, the disclosed apparatus and method can be applied to other printing technologies. Examples include offset printing and inkjet and solid ink transfix machines.

FIGS. 3A-3B depict the fusing configurations 300A-B using a fuser roller shown in FIG. 1 in accordance with the present teachings. The configurations 300 A-B can include a fuser roller 100 (i.e., 100 of FIG. 1) that forms a fuser nip with a pressure applying mechanism 335, such as a pressure roller in FIG. 3A or a pressure belt in FIG. 3B, for an image supporting material 315. In various embodiments, the pressure applying mechanism 335 can be used in combination with a heat lamp 337 to provide both the pressure and heat for the fusing process of the toner particles on the image supporting material 315. In addition, the configurations 300A-B can include one or more external heat roller 350 along with, e.g., a cleaning web 360, as shown in FIG. 3A and FIG. 3B.

FIGS. 4A-4B depict fusing configurations 400A-B using a fuser belt shown in FIG. 2 in accordance with the present teachings. The configurations 400A-B can include a fuser belt 200 (i.e., 200 of FIG. 2) that forms a fuser nip with a pressure applying mechanism 435, such as a pressure roller in FIG. 4A or a pressure belt in FIG. 4B, for a media substrate 415. In various embodiments, the pressure applying mechanism 435 can be used in a combination with a heat lamp to provide both the pressure and heat for the fusing process of the toner particles on the media substrate 415. In addition, the configurations 400A-B can include a mechanical system 445 to move the fuser belt 200 and thus fusing the toner particles and forming images on the media substrate 415. The mechanical system 445 can include one or more rollers 445a-c, which can also be used as heat rollers when needed.

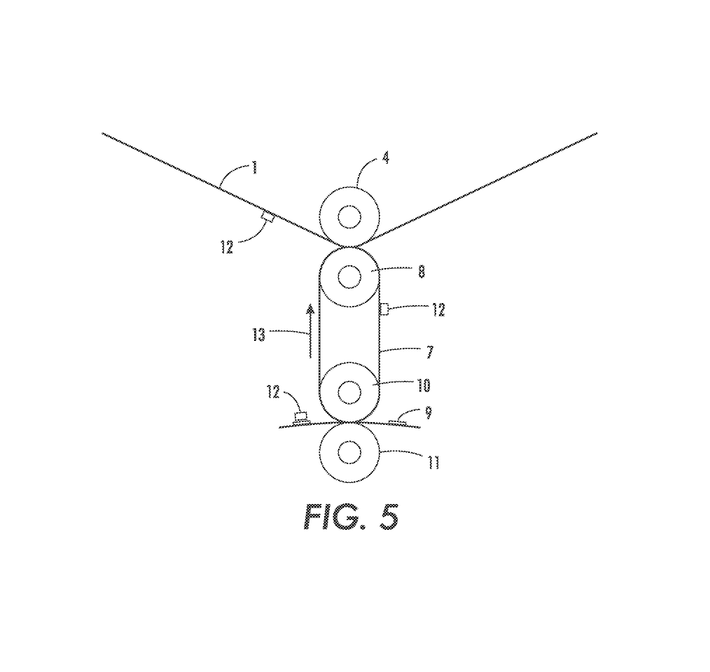

FIG. 5 demonstrates a view of an embodiment of a transfix member 7 which may be in the form of a belt, sheet, film, or like form. The transfix member 7 is constructed similarly to the fuser belt 200 described above. The developed image 12 positioned on intermediate transfer member 1 is brought into contact with and transferred to transfix member 7 via rollers 4 and 8. Roller 4 and/or roller 8 may or may not have heat associated therewith. Transfix member 7 proceeds in the direction of arrow 13. The developed image is transferred and fused to a copy substrate 9 as copy substrate 9 is advanced between rollers 10 and 11. Rollers 10 and/or 11 may or may not have heat associated therewith.

The fuser surface layer includes a metal mesh of non-woven matrix of polymer fibers surrounded by a metal layer. A networked fluoropolymer is dispersed throughout metal mesh. In another embodiment, the release layer includes two distinct layers, a surface layer of fluoropolymer which is supported metal mesh having the fluoropolymer dispersed throughout the metal mesh.

Nonwoven fabrics are broadly defined as sheet or web structures bonded together by entangling fiber or filaments (and by perforating films) mechanically, thermally or chemically. They include flat, porous sheets that are made directly from separate fibers or from molten plastic or plastic film. They are not made by weaving or knitting and do not require converting the fibers to yarn.

The fuser topcoat is fabricated by applying the polymer fibers onto a substrate by an electrospinning process. Electrospinning uses an electrical charge to draw very fine (typically on the micro or nano scale) fibers from a liquid. The charge is provided by a voltage source. The process does not require the use of coagulation chemistry or high temperatures to produce solid threads from solution. This makes the process particularly suited to the production of fibers using large and complex molecules such as polymers. When a sufficiently high voltage is applied to a liquid droplet, the body of the liquid becomes charged, and electrostatic repulsion counteracts the surface tension and the droplet is stretched. At a critical point a stream of liquid erupts from the surface. This point of eruption is known as the Taylor cone. If the molecular cohesion of the liquid is sufficiently high, stream breakup does not occur and a charged liquid jet is formed.

Electrospinning provides a simple and versatile method for generating ultrathin fibers from a rich variety of materials that include polymers, composites and ceramics. To date, numerous polymers with a range of functionalities have been electrospun as nanofibers. In electrospinning, a solid fiber is generated as the electrified jet (composed of a highly viscous polymer solution with a viscosity range of from about 1 to about 400 centipoises, or from about 5 to about 300 centipoises, or from about 10 to about 250 centipoises) is continuously stretched due to the electrostatic repulsions between the surface charges and the evaporation of solvent. Suitable solvents include dimethylformamide, dimethylacetamide, 1-methyl-2-pyrrolidone, tetrahydrofuran, a ketone such as acetone, methylethylketone, dichloromethane, an alcohol such as ethanol, isopropyl alcohol, water and mixtures thereof. The weight percent of the polymer in the solution ranges from about 1 percent to about 60 percent, or from about 5 percent to about 55 percent to from about 10 percent to about 50 percent.

Exemplary materials used for the electrospun fiber with or without a fluoropolymer sheath can include: polyamide such as aliphatic and/or aromatic polyamide, polyester, polyimide, fluorinated polyimide, polycarbonate, polyurethane, polyether, polyoxadazole, polybenzimidazole, polyacrylonitrile, polycaprolactone, polyethylene, polypropylenes, acrylonitrile butadiene styrene (ABS), polybutadiene, polystyrene, polymethyl-methacrylate (PMMA), poly(vinyl alcohol), poly(ethylene oxide), polylactide, poly(caprolactone), poly(ether imide), poly(ether urethane), poly(arylene ether), poly(arylene ether ketone), poly(ester urethane), poly(p-phenylene terephthalate), cellulose acetate, poly(vinyl acetate), poly(acrylic acid), polyacrylamide, polyvinylpyrrolidone, hydroxypropylcellulose, poly(vinyl butyral), poly(alkly acrylate), poly(alkyl methacrylate), polyhydroxybutyrate, fluoropolymer, poly(vinylidene fluoride), poly(vinylidene fluoride-co-hexafluoropropylene), fluorinated ethylene-propylene copolymer, poly(tetrafluoroethylene-co-perfluoropropyl vinyl ether), poly((perfluoroalkyl)ethyl methacrylate), cellulose, chitosan, gelatin, protein, and mixtures thereof. In embodiments, the electrospun fibers can be formed of a tough polymer such as Nylon, polyimide, and/or other tough polymers.

Exemplary materials used for the electrospun fibers when there is no sheath or coating include fluoropolymers selected from the group consisting of: copolymers of vinylidenefluoride, hexafluoropropylene and tetrafluoropropylene and tetrafluoroethylene; terpolymers of vinylidenefluoride, hexafluoropropylene and tetrafluoroethylene; tetrapolymers of vinylidenefluoride, hexafluoropropylene, tetrafluoroethylene, and a cure site monomer; polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP) and a cure site monomer.

In embodiments, fluorinated polyimides (FPI) are used for the core with or without a sheath of the polymers in the non-woven matrix layer. Fluorinated polyimides are synthesized in high molecular weight using a known procedure as shown in Equation 1.

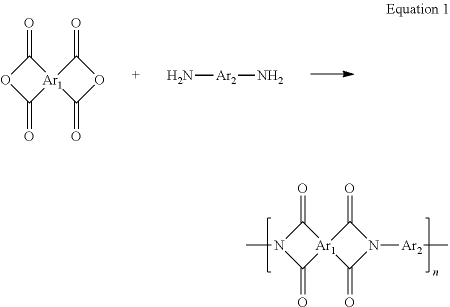

wherein one of wherein Ar₁ and Ar₂ independently represent an aromatic group of from about 4 carbon atoms to about 60 carbon atoms; and at least one of Ar₁ and Ar₂ further contains fluorine. In the polyimide above, n is from about 30 to about 1000, or from about 40 to about 450 or from about 50 to about 400.

More specific examples of fluorinated polyimides include the following general formula:

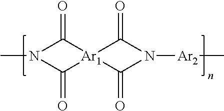

wherein Arand Ar₂ independently represent an aromatic group of from about 4 carbon atoms to about 100 carbon atoms, or from about 5 to about 60 carbon atoms, or from about 6 to about 30 carbon atoms such as such as phenyl, naphthyl, perylenyl, thiophenyl, oxazolyl; and at least one of Ar₁ and Ar₂ further contains a fluoro-pendant group. In the polyimide above, n is from about 30 to about 500, or from about 40 to about 450 or from about 50 to about 400.

Ar₁ and Ar₂ can represent a fluoroalkyl having from about 4 carbon atoms to about 100 carbon atoms, or from about 5 carbon atoms to about 60 carbon atoms, or from about 6 to about 30 carbon atoms.

In embodiments, the electrospun fibers can have a diameter ranging from about 5 nm to about 50 μm, or ranging from about 50 nm to about 20 μm, or ranging from about 100 nm to about 1 μm. In embodiments, the electrospun fibers can have an aspect ratio about 100 or higher, e.g., ranging from about 100 to about 1,000, or ranging from about 100 to about 10,000, or ranging from about 100 to about 100,000. In embodiments, the non-woven fabrics can be non-woven nano-fabrics formed by electrospun nanofibers having at least one dimension, e.g., a width or diameter, of less than about 1000 nm, for example, ranging from about 5 nm to about 500 nm, or from 10 nm to about 100 nm.

In embodiments, the sheath on the polymer fibers is formed by coating the polymer fiber core with a fluoropolymer and heating the fluoropolymer. The fluoropolymers have a curing or melting temperature of from about 150° C. to about 360° C. or from about 280° C. to about 330° C. The thickness of the sheath can be from about 10 nm to about 200 microns, or from about 50 nm to about 100 microns or from about 200 nm to about 50 microns.

In an embodiment core-sheath polymer fiber can be prepared by co-axial electrospinning of polymer core and the fluoropolymer (such as Viton) to form the non-woven core-sheath polymer fiber layer.

Examples of fluoropolymers useful as the sheath or coating of the polymer fiber include fluoroelastomers. Fluoroelastomers are from the class of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymers of vinylidenefluoride, hexafluoropropylene, tetrafluoroethylene, and a cure site monomer. These fluoroelastomers are known commercially under various designations such as VITON A®, VITON B®, VITON E®, VITON E 60C®, VITON E430®, VITON 910®, VITON GH®; VITON GF®; and VITON ETP®. The VITON® designation is a trademark of E.I. DuPont de Nemours, Inc. The cure site monomer can be 4-bromoperfluorobutene-1, 1,1-dihydro-4-bromoperfluorobutene-1, 3-bromoperfluoropropene-1, 1,1-dihydro-3-bromoperfluoropropene-1, or any other suitable, known cure site monomer, such as those commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene), and FLUOREL II® (LII900) a poly(propylene-tetrafluoroethylenevinylidenefluoride), both also available from 3M Company, as well as the Tecnoflons identified as FOR-60KIR , FOR-LHF®, NM® FOR-THF®, FOR-TFS®, TH®, NH®, P757®, TNS®, T439®, PL958®, BR9151® and TN505®, available from Solvay Solexis.

Examples of three known fluoroelastomers are (1) a class of copolymers of two of vinylidenefluoride, hexafluoropropylene, and tetrafluoroethylene, such as those known commercially as VITON A®; (2) a class of terpolymers of vinylidenefluoride, hexafluoropropylene, and tetrafluoroethylene known commercially as VITON B®; and (3) a class of tetrapolymers of vinylidenefluoride, hexafluoropropylene, tetrafluoroethylene, and cure site monomer known commercially as VITON GH® or VITON GF®.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer.

Examples of fluoropolymers useful as the sheath or coating on the polymer fiber core include fluoroplastics. Fluoroplastics suitable for use herein include fluoropolymers comprising a monomeric repeat unit that is selected from the group consisting of vinylidene fluoride, hexafluoropropylene, tetrafluoroethylene, perfluoroalkylvinylether, and mixtures thereof. Examples of fluoroplastics include polytetrafluoroethylene (PTFE); perfluoroalkoxy polymer resin (PFA); copolymer of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP), and mixtures thereof.

In embodiments, the electrospun fibers can have a diameter ranging from about 5 nm to about 50 μm, or ranging from about 50 nm to about 20 μm, or ranging from about 100 nm to about 1 μm. In embodiments, the electrospun fibers can have an aspect ratio about 100 or higher, e.g., ranging from about 100 to about 1,000, or ranging from about 100 to about 10,000, or ranging from about 100 to about 100,000. In embodiments, the non-woven fabrics can be non-woven nano-fabrics formed by electrospun nanofibers having at least one dimension, e.g., a width or diameter, of less than about 1000 nm, for example, ranging from about 5 nm to about 500 nm, or from 10 nm to about 100 nm.

After forming a non-woven polymer fiber matrix on the fuser substrate, a dispersion of a metal is coated on the matrix and heated to remove the solvent and anneal the metal forming a metal mesh. Examples of metal in the dispersion include copper, silver, gold, zinc, palladium and platinum.

The metal core includes metals such as copper, silver, zinc, gold, nickel, platinum and palladium. Examples of solvent used to in the dispersion or metal ink include organic solvents such as decalin, toluene, water, dimethylformamide (DMF). The dispersion can include a stabilizer such as an organoamine or an organic carboxylate. The metal is in the form of nanoparticles having a size less than 10 nm. The dispersion is mixed and filtered prior to use. The resulting metal ink dispersion has a solids content of from about 20 weight percent to about 60 weight percent or from about 25 weight percent to about 55 weight percent or from about 30 weight percent to about 50 weight percent.

After coating the metal dispersion on the non-woven polymer fiber matrix, the dispersion is heated at a temperature of about 100° C. to about 250° C., or from about 120° C. to about 240° C., or from about 130° C. to about 230° C. for a time sufficient to remove the solvent and anneal the metal forming a metal coated non-woven polymer fiber mesh having pores of a size of from about 1 micron to about 50 microns having fluoropolymer dispersed throughout is described. In embodiments, the pores are the order of 5 microns to about 40 microns, or from about 10 microns to about 35 microns. The metal of the resulting metal coated non-woven polymer fiber mesh includes about 1 weight percent to about 80 weight percent, or from about 5 weight percent to about 70 weight percent or from about 10 weight percent to about 60 weight percent of the of the metal coated non-woven polymer fiber mesh.

The electrical resistivity of the metal coated non-woven polymer fiber mesh is from about 10² to about 10⁸ Ω/cm and the thermal conductivity is from about 0.1 W/mK to about 10 W/mK.

A fluoropolymer coating is provided within and on top of the metal mesh. The fluoropolymer coating composition can include, an effective solvent, in order to disperse the fluoropolymer and optionally, inorganic filler particles that are known to one of ordinary skill in the art.

The effective solvents can include water and/or organic solvents including, but not limited to, methyl isobutyl ketone (MIBK), acetone, methyl ethyl ketone (MEK), and mixtures thereof. Other solvents that can form suitable dispersions can be within the scope of the embodiments herein.

In various embodiments, the coating composition can be coated using, for example, coating techniques, extrusion techniques and/or molding techniques. As used herein, the term “coating technique” refers to a technique or a process for applying, forming, or depositing a dispersion to a material or a surface. Therefore, the term “coating” or “coating technique” is not particularly limited in the present teachings, and dip coating, painting, brush coating, roller coating, pad application, spray coating, spin coating, casting, or flow coating can be employed.

The fluoropolymer coating is cured or melted at a temperature of from about 255° C. to about 360° C. or from about 280° C. to about 330° C.

Fluoropolymers suitable for use as in the release layer having the metal mesh include fluoropolymers listed previously. Fluoroplastics have a melting temperature of from about 280° C. to about 400° C. or from about 290° C. to about 390° C. or from about 300° C. to about 380° C. while fluoroelastomers are cured at a temperature of from about 80° C. to about 250° C.

The release layer of metal coated non-woven polymer fiber mesh having fluoropolymer dispersed throughout has a thickness of from about 10 μm to about 400 μm, or from about 20 μm to about 300 μm, or from about 25 μm to about 200 μm.

The metal coated non-woven polymer fiber mesh has a thickness of from about 5 μm to about 100 μm, or from about 10 μm to about 80 μm, or from about 15 μm to about 50 μm.

Specific embodiments will now be described in detail. These examples are intended to be illustrative, and not limited to the materials, conditions, or process parameters set forth in these embodiments. All parts are percentages by solid weight unless otherwise indicated.

### EXAMPLES

A solution containing 8 weight percent fluorinated polyimide (FPI) in methyl ethyl ketone (MEK) was loaded into a 10 mL syringe. A second solution of 8 weight percent Viton GF® in MEK with 5 weight percent AO700 was loaded into a 10 mL syringe. The two syringes were mounted into their respective syringe pumps, and the syringes were connected to the coaxial spinneret with the FPI on the core channel and the Viton on the shell channel. A silicone fuser roll was wiped clean using isopropanol, and placed onto a fixture (with X-stage and rotation) approximately 15 cm away from the spinneret tip. About 20 kv was applied at the spinneret. Fibers with about 1 μm diameter were generated and coated on the roll. As-spun fiber mat was set at room temperature overnight and then heat-treated with Viton/AO700 baking cycle.

A silver nanoparticle ink dispersion was prepared by adding 15.32 gram of decalin into 10.21 gram of silver nanoparticles having a size less than 10 nm. The dispersion was with an organoamine. The mixture was stirred for 24 hours and filtered with 1 um syringe filter, resulting a silver nanoparticle ink dispersion with 40 weight percent solid content in decalin.

The silver ink dispersion was flow-coated onto the fiber mat. The specifics of the coating conditions were: flow rate was 1.8 ml/min; roll RPM was 123; coating speed was 2 mm/sec; and the blade y-axis position was 59 mm.

The silver coated fiber mat roll was heated to about 130° C. for about 20 minutes resulting in a silver mesh. The silver mesh had an electrical resistance of about 200Ω.

Polytetrafluoroethylene (Teflon® AF2400) was coated onto the silver mesh by flow-coating process. The coating was then heated about 300° C. for 10 minutes resulting in a thermally conductive fuser topcoat. The surface coating enables fusing at lower temperatures and extended fuser life.

It will be appreciated that variants of the above-disclosed and other features and functions or alternatives thereof may be combined into other different systems or applications. Various presently unforeseen or unanticipated alternatives, modifications, variations, or improvements therein may be subsequently made by those skilled in the art, which are also encompassed by the following claims.

What is claimed is:

1. A fuser member comprising:
a substrate; and
a release layer disposed on the substrate, the release layer having a metal coated non-woven polymer fiber mesh having pores of a size of from about 1 microns to about 50 microns, and a fluoropolymer dispersed throughout the metal coated non-woven polymer fiber mesh.

2. The fuser member of claim 1, wherein the metal coated non-woven polymer fiber mesh comprises from about 1 weight percent to about 80 weight percent of the release layer.

3. The fuser member of claim 1, wherein polymer fibers of the metal coated non-woven polymer fiber mesh have a diameter of from about 5 nm to about 50 microns.

4. The fuser member of claim 1, wherein polymer fibers of the metal coated non-woven polymer fiber mesh comprise a material selected from the group consisting of a polyamide, a polyester, a polyimide, a polycarbonate, a polyurethane, a polyether, a polyoxadazole, a polybenzimidazole, a polyacrylonitrile, a polycaprolactone, a polyethylene, a polypropylene, a acrylonitrile butadiene styrene (ABS), a polybutadiene, a polystyrene, a polymethyl-methacrylate (PMMA), a polyhedral oligomeric silsesquioxane (POSS), a poly(vinyl alcohol), a poly(ethylene oxide), a polylactide, a poly(caprolactone), a poly(ether imide), a poly(ether urethane), a poly(arylene ether), a poly(arylene ether ketone), a poly(ester urethane), a poly(p-phenylene terephthalate), a cellulose acetate, a poly(vinyl acetate), a poly(acrylic acid), a polyacrylamide, a polyvinylpyrrolidone, hydroxypropylcellulose, a poly(vinyl butyral), a poly(alkly acrylate), a poly(alkyl methacrylate), polyhydroxybutyrate, fluoropolymer, a poly(vinylidene fluoride), a poly(vinylidene fluoride-co-hexafluoropropylene), a fluorinated ethylene-propylene copolymer, a poly(tetrafluoroethylene-co-perfluoropropyl vinyl ether), a poly((perfluoroalkyl)ethyl methacrylate), a cellulose, a chitosan, a gelatin, a protein, and mixtures thereof

5. The fuser member of claim 1 wherein polymer fibers of the metal coated non-woven polymer fiber mesh comprise a fluorinated polyimide having a chemical structure as follows: 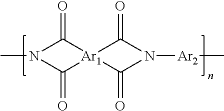
wherein Ar₁ and Ar₂ independently represent an aromatic group of from about 4 carbon atoms to about 100 carbon atoms; and wherein at least one of Ar₁ and Ar₂ further contains a fluoro-pendant group wherein n is from about 30 to about 1000.

6. The fuser member of claim 1, wherein the release layer further comprises conductive particles selected from the group consisting of: carbon black, graphene, graphite, carbon nanotubes, alumina, tin oxide, antimony dioxide, antimony-doped tin oxide, titanium dioxide, indium oxide, zinc oxide, indium oxide and indium-doped tin trioxide, polyaniline and polythiophene dispersed in the release layer.

7. The fuser member of claim 1, wherein the metal in the metal coated non-woven polymer fiber mesh is selected from the group consisting of copper, silver, zinc, gold, palladium, platinum.

8. The fuser member of claim 1, wherein the metal in the metal coated non-woven polymer fiber mesh has a thickness of from about 5 microns to about 100 microns.

9. The fuser member of claim 1, wherein polymer fibers of the non-woven polymer fiber mesh have a fluoropolymer sheath.

10. The fuser member of claim 1, wherein the fluoropolymer comprises a fluoroelastomer selected from the group consisting of copolymers of: vinylidenefluoride, hexafluoropropylene and tetrafluoropropylene and tetrafluoroethylene, terpolymers of vinylidenefluoride, hexafluoropropylene and tetrafluoroethylene, tetrapolymers of vinylidenefluoride, hexafluoropropylene, tetrafluoroethylene, and a cure site monomer.

11. The fuser member of claim 1, wherein the fluoropolymer comprises a fluoroplastic selected from the group consisting of polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP) and a cure site monomer; and mixtures thereof

12. A fuser member comprising:
a substrate;
an intermediate layer disposed on the substrate selected from the group consisting of fluoroelastomer and silicone; and
a release layer disposed on the intermediate layer, the release layer having a metal coated non-woven polymer fiber mesh having pores of a size of from about 1 microns to about 50 microns, and a fluoropolymer dispersed throughout the metal coated non-woven polymer fiber mesh.

13. The fuser member of claim 12, wherein the metal in the metal coated non-woven polymer fiber mesh is selected from the group consisting of copper, silver, zinc, gold, palladium, platinum.

14. The fuser member of claim 12, wherein the metal in the metal coated non-woven polymer fiber mesh has a thickness of from about 5 microns to about 100 microns.

15. The fuser member of claim 12, wherein polymer fibers of the non-woven polymer fiber mesh have a fluoropolymer sheath.

16. A method of manufacturing a fuser member comprising:
providing a conductive substrate electrospinning polymeric fibers on the conductive surface to form a non-woven polymer fiber layer;
coating a metal particle dispersion on the polymeric fibers;
annealing the metal particle dispersion to form a metal coated non-woven polymer fiber mesh having pores having a size of from about 1 microns to about 50 microns;
coating a mixture of a fluoropolymer and a solvent on the metal coated non-woven polymer fiber mesh;
heating the mixture to remove the solvent and melt or cure the fluoropolymer thereby having the fluoropolymer penetrate the metal coated non-woven polymer fiber mesh.

17. The method of claim 16 wherein the metal particle dispersion comprises, metal particles having a size of less than 10 nm, and organic solvent and stabilizer selectedfrom the group consisting of organoamines and organic carboxylates.

18. The method of claim 16 wherein the metal of the metal particle dispersion is selected from the group consisting of copper, silver, zinc, gold, palladium, platinum.

19. The method of claim 16 wherein the metal particle dispersion has a solids content of from about 20 weight percent to about 60 weight percent.

20. The method of claim 16, further comprising:
filtering the metal particle dispersion prior to coating the dispersion.
